(19) United States
(12) Patent Application Publication
(10) Pub. No.: US 2013/0305383 A1
(43) Pub. Date: Nov. 14, 2013

(54) SYSTEM AND METHOD TO PROTECT USER PRIVACY IN MULTIMEDIA UPLOADED TO INTERNET SITES

(71) Applicants: Pablo Garralda, Cordoba (AR); Pablo Passera, Alta Garcia (AR); Dan Hirch, Cordoba (AR); Pablo Michelis, Cordoba (AR); Francisco Cuenca-Acuna, Cordoba (AR); Leandro Cino, Cordoba (AR); German Bruno, Cordoba (AR)

(72) Inventors: Pablo Garralda, Cordoba (AR); Pablo Passera, Alta Garcia (AR); Dan Hirch, Cordoba (AR); Pablo Michelis, Cordoba (AR); Francisco Cuenca-Acuna, Cordoba (AR); Leandro Cino, Cordoba (AR); German Bruno, Cordoba (AR)

(73) Assignee: INTEL CORPORATION, Santa Clara, CA (US)

(21) Appl. No.: 13/997,108

(22) PCT Filed: Dec. 12, 2011
(86) PCT No.: PCT/US11/64492

§ 371 Date: Jun. 21, 2013

Related U.S. Application Data
(60) Provisional application No. 61/426,055, filed on Dec. 22, 2010.

(51) Int. Cl. G06F 21/60

(52) U.S. Cl. CPC G06F 21/60
USPC 726/26

(57) ABSTRACT

A system and method for protecting user privacy in multimedia uploaded to Internet sites. Briefly stated, the method includes receiving, by a server hosting an Internet privacy protection service, a media item of a subscriber of the service from a social networking service. The media item is encrypted using Digital Rights Management techniques. Policy determining who can view the media item is generated. The encrypted media item is securely stored in a cloud storage network. Storage information, including a URL of the secure storage location for the encrypted media item, is received by the Internet privacy protection service from the cloud storage network. The Internet privacy protection service generates a proxy image by encoding the URL into the proxy image using a bar code. The Internet privacy protection service uploads the proxy image to the subscriber's social networking service account on the social networking service.

### CROSS-REFERENCE TO RELATED APPLICATIONS

The present application claims the benefit of priority to U.S. Provisional Patent Application No. 61/426,055 filed on Dec. 22, 2010.

### BACKGROUND OF THE INVENTION

1. Field of the Invention

The present invention is generally related to the field of social networking. More particularly, the present invention is related to systems, methods, and machine accessible storage mediums to protect user privacy in multimedia content uploaded to Internet sites, such as, for example, social networking sites.

2. Description

Today, more than one billion people from all around the world interact via the Internet with Social Networks. Privacy is a huge concern for an end consumer interacting with Internet social networking sites. When an end consumer uploads or posts a picture/video to an Internet social networking site, the end user has no assurances as to where the picture/video may end up. In other words, the end consumer posting the picture/video loses control over the distribution and reproduction of the picture/video as well as who may have access to the picture/video. For example, the picture/video may be copied and pasted to any blog and/or web site and/or communicated to anyone via email. In other words, anyone can publish the picture/video without the end consumer's permission or knowledge. And although protection mechanisms, such as, for example, Digital Rights Management, do exist, formatting schemes for these protection mechanisms may be different.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 illustrates an exemplary system in which an Internet privacy protection service operates according to an embodiment of the present invention.

FIG. 2 is a flow diagram describing an exemplary method for monitoring a subscriber's appearance according to an embodiment of the present invention.

FIG. 3 is an exemplary diagram illustrating a method for enabling a user to see a protected image according to an embodiment of the present invention.

FIG. 4 is a flow diagram describing an exemplary method for generating a proxy image according to an embodiment of the present invention.

FIG. 5 is a flow diagram illustrating an exemplary method for protecting downloaded images according to an embodiment of the present invention.

FIG. 6 is a flow diagram describing an exemplary method for uploading multimedia according to an embodiment of the present invention.

FIG. 7 is a flow diagram illustrating an alternative exemplary method for uploading multimedia according to an embodiment of the present invention.

FIG. 8 is a flow diagram illustrating an alternative exemplary method for viewing multimedia according to an embodiment of the present invention.

FIG. 9 is a flow diagram illustrating an exemplary method for adding, removing, and/or modifying access permissions for a media item at any time according to an embodiment of the present invention.

FIG. 10 is an example implementation of a computer system according to an embodiment of the present invention.

### DETAILED DESCRIPTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Embodiments of the present invention are directed to an Internet privacy protection service for protecting the privacy of user multimedia uploaded to social networking sites. Multimedia may include text, still images, animation, video, movies, pictures, printed material, audio, sound, graphics, and combinations thereof. Embodiments of the present invention control who can view multimedia instead of who can download multimedia. Only those authorized by the subscriber will be able to view the multimedia. In order to protect a subscriber's multimedia, embodiments of the present invention encrypt every multimedia item that a subscriber uploads to a social network site. Later when a subscriber's friend wants to view one or more of the subscriber's multimedia items, the service checks the multimedia item's access policy and, if access is granted, the service delivers a license and a decrypting key to the requester (i.e., user's friend). The license restricts the requester to the actions permitted in the license. A tamper resistant plug-in within the browser interprets the license and decrypts the media content.

Embodiments of the present invention allow the modification of access policies even after the media has already been released. This is accomplished by confirming access every time the media is viewed.

Embodiments of the present invention monitor the subscriber's face, using face recognition technology, on all multimedia uploaded to the social networks. During the subscription to the privacy protection service, a signature of the subscriber's face is created to help detect the subscriber's face on multimedia published on the subscriber's social circle across multiple social networks. The signature may be used to search the multimedia uploaded to the social networks for any matches. When a match is found, the subscriber is notified. In embodiments where a subscriber may be associated with multiple social networks, each social network will be searched.

Subscribers may be associated with multiple social networks. Each social network may have different privacy settings with different complexities. Embodiments of the present invention provide a mechanism to configure privacy settings for one or more multiple social network sites from a centralized point, enabling the subscriber to configure and manage their privacy settings more easily. An interface is used to allow the subscriber to manage user privacy configurations for multiple social networks. The subscriber accesses the privacy configurations through a social network application. Once the privacy configurations have been set, they are propagated to multiple social networking sites via the Social Networks' APIs (Application Program Interfaces).

Embodiments of the present invention also provide a method to integrate DRM or similar protection schema for protecting images, and other similar media, within social networks, blogging or similar Internet sites without requiring the support of additional file formats by the social networks, blogging or similar Internet sites. In one embodiment, this is accomplished by using proxy images with an embedded ID (identification) code as part of the image. The code references the actual image, which is securely stored in a server, which is part of the reference infrastructure and handles the DRM protection and access control mechanisms. For de-referencing the image, a browser or OS plug-in may be used to scan the images and detect embedded code in the proxy images. Upon user authentication, the plug-in uses the reference code (ID code), extracted from the proxy images, to fetch the actual image from the secure storage. In an alternative embodiment, instead of embedding the ID code in the image, the ID code may be part of the image metadata. In this alternative embodiment, the proxy image comprises a blurred version of the original image, with the location of the original image being located in the image metadata. The browser or OS plug-in ensures that this process is transparent to the user. DRM mechanisms included as part of the plug-in ensure that the user or program accessing the image make proper use of the actual image. In other words, DRM mechanisms prevent un-authorized copies of the image.

In various embodiments, apparatuses may be endowed with hardware and/or software configured to practice one or more aspects of the above described embodiments of the methods of the present invention. In various embodiments, an article of manufacture with tangible, non-transitory computer-readable storage mediums may be provided with programming instructions configured to cause an apparatus, in response to execution of the programming instructions by the apparatus, to practice one or more aspects of the above described embodiments of the methods of the present invention.

Although the present invention is described with respect to a social networking context, the invention is not limited to images and the like on social networking sites. One skilled in the art would know that the present invention is also applicable to the protection of any uploaded image on the Internet, such as, for example, a blog Internet site, a web site or Internet site in which images or other multimedia may be uploaded, emails in which images or other multimedia may be uploaded, etc. In other words, embodiments of the Internet privacy protection service may protect any image or the like uploaded to the Internet.

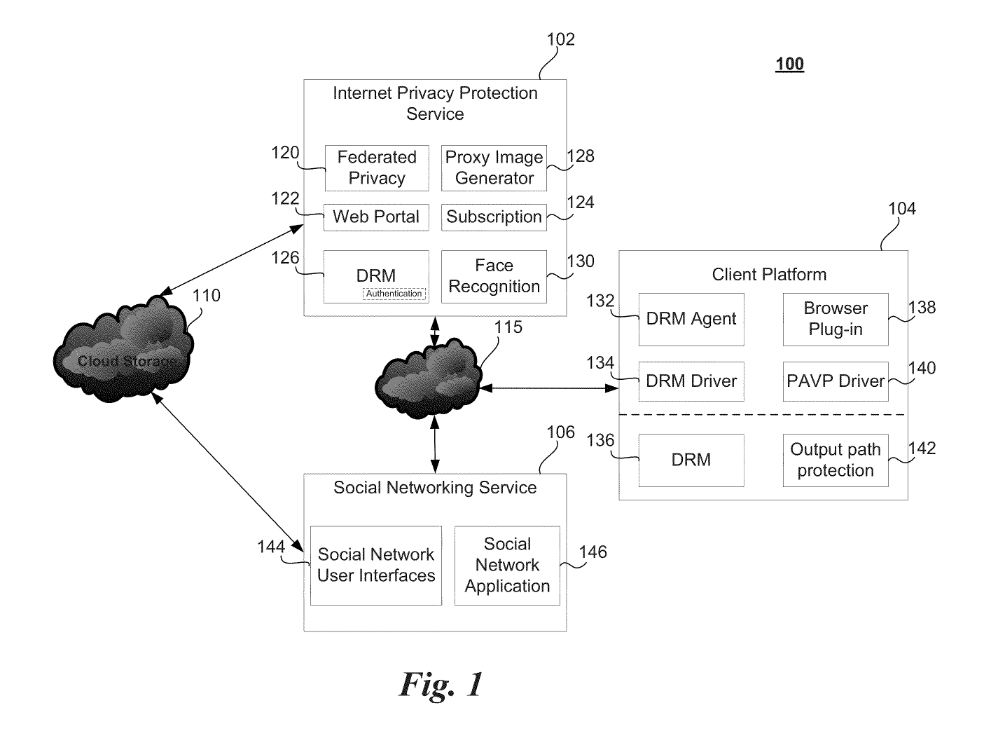

FIG. 1 illustrates an exemplary system 100 in which an Internet privacy protection service operates according to an embodiment of the present invention. As shown in FIG. 1, system 100 includes an Internet privacy protection (IPP) service 102, a client platform 104, and a social networking service 106. System 100 also shows a cloud storage network 110 coupled to the social networking service 106 and IPP service 102. IPP service 102, social networking service 106, and client platform 104 communicate over a wide area network 115, such as, for example, the Internet.

IPP service 102 may be implemented in hardware, software, or a combination thereof on one or more servers. IPP service 102 provides a mechanism to allow a user, interfacing with the IPP service 102 via the client platform 104 and/or the social networking service 106, to completely control access to their media, even after the media is published. IPP service 102 also provides a mechanism to detect any privacy breaches that a user may experience. IPP service 102 comprises a federated privacy module 120, a web portal 122, a subscription module 124, a DRM (Digital Rights Management) module 126, a proxy image generator 128, and a face recognition module 130.

Federated privacy module 120 provides a centralized point to enable a subscriber to configure the subscriber's privacy policy for a plurality of social networks. Federated privacy module 120 may be responsible for handling privacy and other settings associated with the plurality of social networks. The settings may include, but are not limited to, privacy settings associated with each social network, privacy settings associated with each media item of a subscriber, unified user contacts across social networks, and unified group contacts. Federated privacy module 120 allows a subscriber to manage their settings for a plurality of social networks from one place, namely the IPP service 102.

In embodiments of the present invention, a subscriber may access the IPP service 102 from the social networking service 106. In embodiments of the present invention, a subscriber may also access the IPP service 102 directly through web portal 122. Thus, web portal 122 provides a direct interface between the IPP service 102 and a subscriber. In other words, the subscriber may access the IPP service via the web portal 122 without having to go through the social networking service 106. The web portal 122 allows a subscriber to modify subscription and privacy features. For example, the web portal 122 may allow a subscriber to view all of their media and to interact with the federated privacy module to update policy for any of the subscriber's media items. Updating policy may include, but is not limited to, adding and/or deleting access permissions to a media item as well as removing all access permissions to the media item. The web portal 122 may also allow a subscriber to modify their subscription information. For example, a subscriber may change their credit card information, add a new social network site, or delete a social network site.

Subscription module 124 manages the process of obtaining and maintaining subscriptions with the IPP service 102 from a plurality of subscribers via client platforms, such as client platform 104. Subscription module 124 handles the acceptance of terms and conditions for subscribers, payment registration, payment confirmation, payments vs. trial options, etc. In one embodiment, a person may subscribe to the IPP service 102 from the social networking service 106 by clicking on a link identifying the IPP service 102.

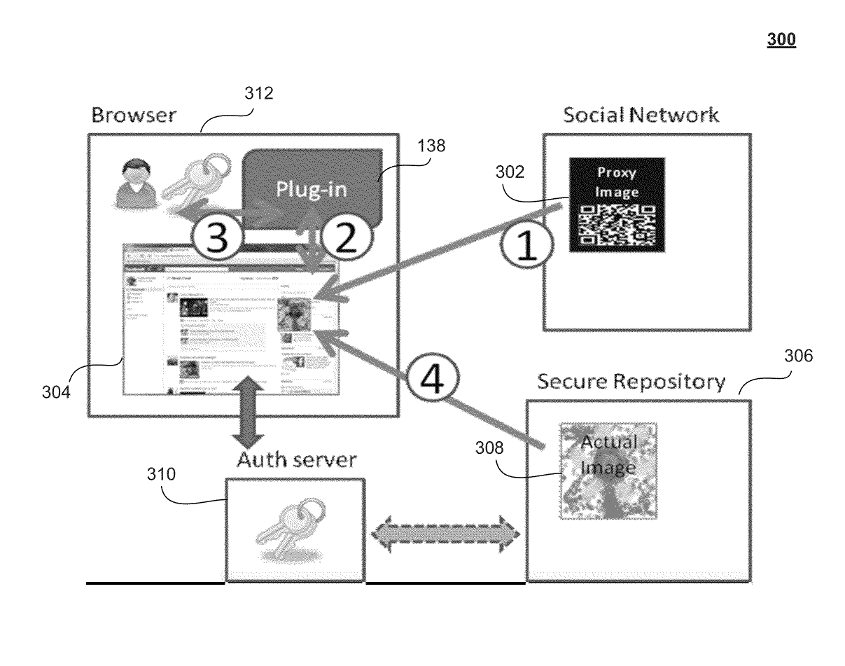

DRM module 126 manages server side DRM features. Server side DRM features include, but are not limited to, encrypting multimedia images, authenticating and providing keys to subscriber contacts to decrypt the encrypted multimedia images, encrypting and holding multimedia content, packaging, encrypting and provisioning licenses to subscriber contacts, etc. In one embodiment, DRM module 126 may be housed in one or more DRM server(s) separate from the server(s) housing the IPP service 102. In another embodiment, DRM module 126 may be housed on the same server(s) as the IPP service 102. In one embodiment, the DRM server(s) may provide authentication services (shown in phantom within the DRM module 126) as well as authorization services. In one embodiment, authorization services may reside within the DRM module 126 in an authorization server, shown below in FIG. 3 as authorization server 310. In one embodiment, an authentication server (not shown), separate from the DRM server, may provide authentication services.

The proxy image generator 128 may generate proxy images for the multimedia images uploaded to the social networking service 106 by a subscriber. In one embodiment, the proxy images may be used as placeholders for actual multimedia images until permission to view the multimedia images is verified. In one embodiment, the proxy image may be encoded with the location of the actual media image using a bar code, such as, for example, a QR code (a matrix bar code capable of being read by a QR scanner, a mobile device having a camera, and a smartphone). In another embodiment, instead of encoding the proxy image with the location of the actual media image, the proxy image may be a blurred version of the actual image and the location of the actual image may be part of the image metadata. In one embodiment, the location may be a URL (Uniform Resource Locator) that points directly to the storage location of the actual image. The proxy image is described in more detail with respect to FIG. 3.

Face recognition module 130 monitors a subscriber's appearance on images uploaded by the subscriber's contacts (also referred to as the subscriber's social circle) to any monitored social network. This observation mechanism requires the face recognition module 130 of the IPP service 102 to be trained on the subscriber's face from a set of subscriber pictures. In one embodiment, the subscriber pictures used to train the face recognition module 130 of the IPP service 102 are taken using a web cam (not shown) of client platform 104 and uploaded to the IPP service 102 via web portal 122. In one embodiment, the subscriber pictures may be uploaded to the IPP service 102 via a social network application (to be discussed below) on a social network site. In embodiments of the present invention, the training process may be launched at subscription time. In embodiments, the training process may also be launched manually at the request of the subscriber to improve the recognition process.

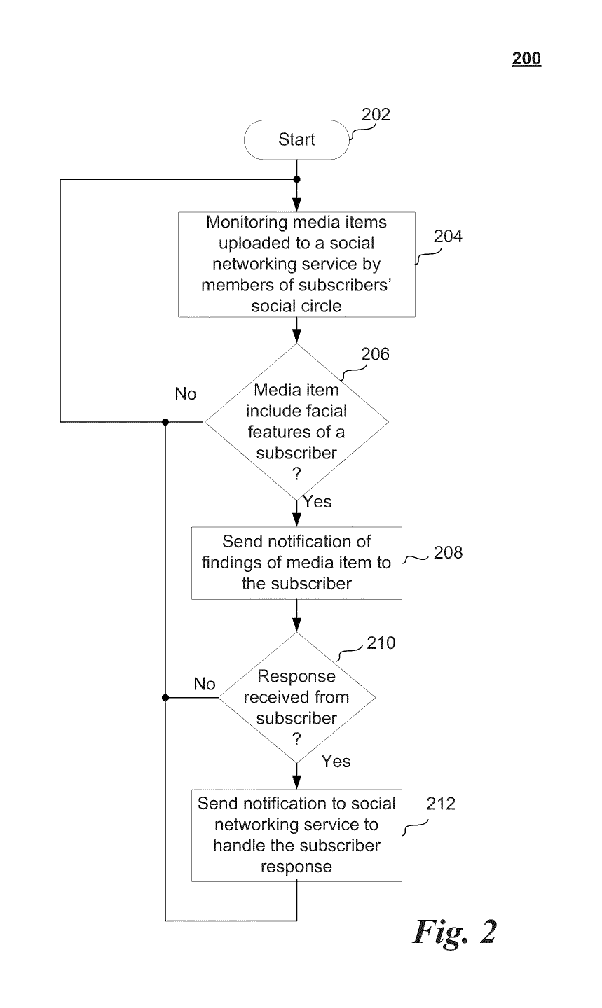

FIG. 2 is a flow diagram 200 describing an exemplary method for monitoring a subscriber's appearance according to an embodiment of the present invention. The invention is not limited to the embodiment described herein with respect to flow diagram 200. Rather, it will be apparent to persons skilled in the relevant art(s) after reading the teachings provided herein that other functional flow diagrams are within the scope of the invention. The process begins with block 202, where the process immediately proceeds to block 204.

In block 204, the face recognition module 130 monitors media items uploaded to a social networking service, such as, for example, social networking service 106, by members of a subscriber's social circle. The media item may be, but is not limited to, a picture or a video in which a subscriber's facial features may be recognizable. The process then proceeds to decision block 206.

In decision block 206, the face recognition module 130 determines whether the media item includes facial features of a subscriber. If it is determined that the media item includes facial features of a subscriber, the process proceeds to block 208.

In block 208, a notification may be generated by the IPP service 102 to inform the subscriber of the media item in block 208. In one embodiment, the notification may include a copy of the image and may require the subscriber to respond by indicating one of: (a) Yes, I am in the media item, and I would like to be tagged; (b) Yes, I am in the media item, but I do not wish to be tagged; (c) No, that is not me in the media item; or (d) Report use of media item without my permission. The process then proceeds to decision block 210.

In decision block 210, it is determined whether a response is received from the subscriber. If a response is received from the subscriber, the process proceeds to block 212.

In block 212, the social networking service 106 is notified of the subscriber response. If the response is (a), the social networking service 106 may be notified to tag the media item with the subscriber's name. If the response is (b), the social networking service 106 may be notified not to tag the media item with the subscriber's name. If the response is (c), the social networking service 106 may not be notified that the media item does not include a subscriber of the IPP service 102. In this instance, the media item may be removed from a list of detected media items in the IPP service 102, and the information may be used to improve facial recognition accuracy. If the response is (d), the social networking service 106 may be notified of the report of use without the subscriber's permission. In this instance, the social networking service 106 may handle the report of use according to policies provided by the social networking service 106. The process then proceeds back to block 204 where the facial recognition module 130 continues to monitor for any media items uploaded by a member of a subscriber's social circle.

Returning to decision block 210, if a response is not received from the subscriber, the process then proceeds back to block 204 where the facial recognition module 130 continues to monitor for any media items uploaded by a member of a subscriber's social circle.

Returning to decision block 206, if it is determined that the media item does not include facial features of a subscriber, the process then proceeds back to block 204 where the facial recognition module 130 continues to periodically check for any media items uploaded by a member of a subscriber's social circle.

Returning to FIG. 1, client platform 104 may be used by a subscriber of the IPP service 102 to directly interact with the IPP service 102 or to interact with the IPP service 102 via a social network application (to be discussed below) on a social networking site, such as, for example, social networking service 106. Client platform 104 comprises, inter alia, a DRM agent 132, a DRM driver 134, a DRM module 136, a browser plug-in 138, a protected audio and video path (PAVP) driver 140, and an output path protection module 142. The DRM agent 132 is coupled to the DRM module 136 via the DRM driver 134. The browser plug-in 138 is coupled to the output path protection module 142 via the PAVP driver 140.

The DRM agent 132 may be responsible for enforcing DRM policies from the IPP service 102 on the client side. The DRM agent 132 may be responsible for validating the license, extracting the key to decrypt the media item, and decrypting the media item. The DRM agent 132 may receive the package (i.e., the encrypted media) and license from the IPP service 102 and, in conjunction with the DRM module 136, decide whether an action may be performed on a multimedia item, such as, for example, a picture. The action may include, but is not limited to, displaying the media item on a display (not explicitly shown) on the client platform 104.

The browser plug-in 138 may be responsible for detecting the proxy image, requesting the encrypted multimedia item and license from the IPP service 102 for the DRM agent, and displaying the multimedia item securely on the user's display device via the output path protection module 142.

The DRM driver 134 configures and provides software access to the DRM 136. In one embodiment, the DRM 136 may comprise hardware that provides a secure execution environment for the DRM agent to verify the license and decrypt the media item securely.

The PAVP driver 140 configures and provides software access to the output path protection module 142. The output path protection module 142 may be a hardware module for protecting the media item when it is being displayed to prevent copying or screen capture of the media item. The PAVP driver 140 may also be used to implement a video driver in order to ensure that the content path up to the video card is secure.

The social networking service 106 may include a social network user interface 144 and a social network application 146. The social network user interface 144 interacts with clients via the client platform 104 to upload multimedia, view uploaded multimedia, and change multimedia permissions. The social network application 146 interacts with the IPP service 102 to provide extended features, such as, for example, subscription processes, extended privacy settings, upload of protected media items, protection of media items already uploaded, etc.

Cloud storage network 110 provides a secure storage service to store the physical encrypted multimedia files. In one embodiment, the cloud storage network 110 may owned and/or operated by the same entity that owns and/or operates IPP service 102. In another embodiment, the cloud storage network 110 may be an Internet service provided by one of a number of companies that offer such cloud storage services.

FIG. 3 is a diagram 300 illustrating an exemplary method for enabling a user to see a protected image according to an embodiment of the present invention. FIG. 3 shows a client-side browser having the browser plug-in 138, a proxy image 302 from a social network web page 304 displayed on a display of client platform 104, a secure repository 306, including actual encrypted images 308 from cloud storage network 110, and an authorization server 310. Authorization server 310 may reside within the DRM module 126.

Client-side browser having browser plug-in 138 shows a page 304 from social networking service 106 retrieved by a user of social networking service 106. If page 304 is a page from a subscriber of Internet privacy protection service 102, page 304 includes a proxy image 302. The user may be a friend of the subscriber of Internet privacy protection service 102.

Proxy images 302 are images stored inside social network sites. Protected images or actual encrypted images 308 are images securely stored in secure repository 306 of cloud storage network 110. In one embodiment of the present invention, actual encrypted images 308 are protected using DRM protection and access control. Proxy image 302 comprises a barcode 312 having an embedded identification (ID) code (not directly shown) that references actual encrypted image 308 being protected. The ID code identifies actual encrypted image 308 as well as the location of actual encrypted image 308 in secure repository 306.

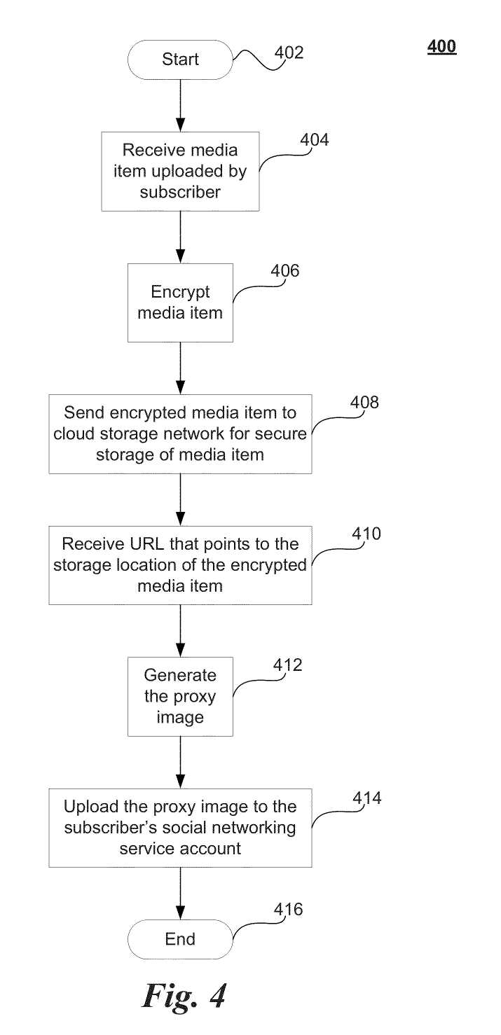

FIG. 4 is a flow diagram 400 describing an exemplary method for generating a proxy image 302 according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The process begins with block 402, where the process immediately proceeds to block 404.

In block 404, a media item is uploaded to the IPP service 102 by a subscriber of the IPP service 102 via social network application 146. The process proceeds to block 406.

In block 406, the media item is encrypted by the DRM module 126. The process then proceeds to block 408.

In block 408, the encrypted media item is sent to cloud storage network 110 for storage in a secure repository, such as secure repository 306. The process then proceeds to block 410.

In block 410, a URL (Uniform Resouce Locator) pointing to the storage location of the encrypted media item is received by the proxy generation module 128 of the IPP service 102. The process then proceeds to block 412.

In block 412, the proxy generation module 128 generates the proxy image 302 by encoding the URL into the proxy image 302 using a bar code. In one embodiment, the bar code may be a QR code, which is well known in the relevant art(s). The process then proceeds to block 414.

In block 414, the proxy generation module 128 of the IPP service 102 uploads the proxy image 302 to the subscriber's social networking service account on the social networking service 106. The process then proceeds to block 416, where the process ends.

Returning to FIG. 3, browser plug-in 138 detects proxy images 302 using well known image recognition techniques. Browser plug-in 138 reads barcode 312 to identify the actual image, including the location of the actual image in secure repository 306. Browser plug-in 138 also verifies the access privileges of the user with regards to the actual image. Browser plug-in 138 may check the access rights of the actual image with the access rights of the user that selected the social network web page 304. To determine whether the user has the appropriate access rights, the federated privacy module 120 is checked to determine whether policies exist for the user to have access to the media item. If the user has the appropriate access rights, browser plug-in 138 may download the actual encrypted image 308 from secure repository 306, decrypt the actual encrypted image 308 using an encryption key 314 obtained from the authorization server 310, and place the actual image over top of proxy image 302. Once the actual image is inside browser 138, DRM protection mechanisms may ensure the proper usage and manipulation of the actual image based on the user's license to the actual image. For example, DRM protection mechanisms may prevent unauthorized copy of the actual image.

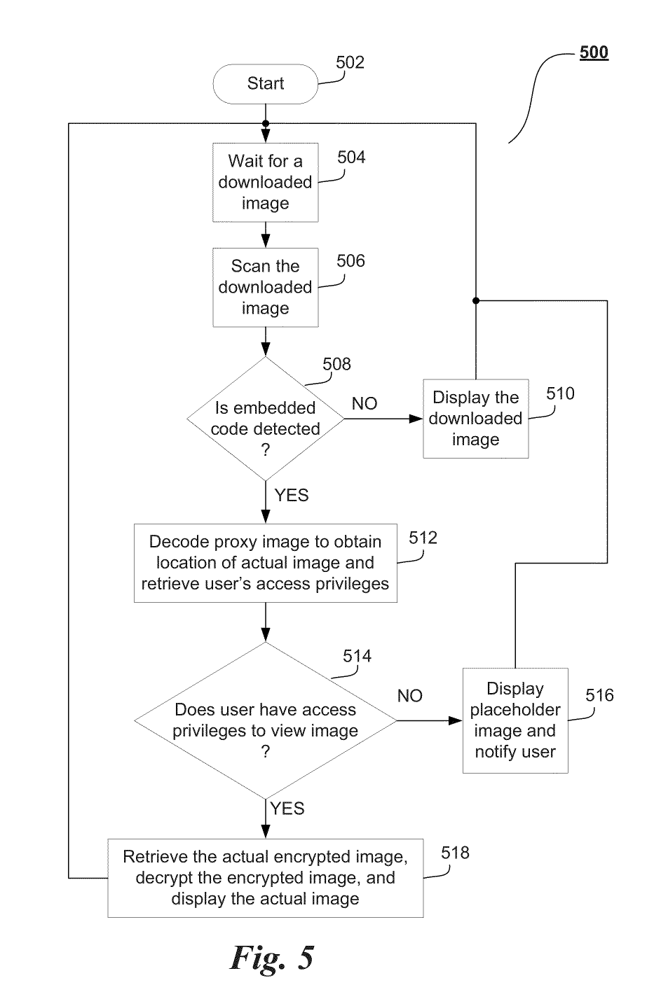

FIG. 5 is a flow diagram 500 illustrating an exemplary method for protecting downloaded images according to an embodiment of the present invention. The invention is not limited to the embodiment described herein with respect to flow diagram 500. Rather, it will be apparent to persons skilled in the relevant art(s) after reading the teachings provided herein that other functional flow diagrams are within the scope of the invention. The process begins with block 502, where the process immediately proceeds to block 504.

In block 504, the browser plug-in 138 waits for a downloaded image. As previously indicated, embodiments of the present invention are described with respect to social networks, but may be implemented wherever images or other multimedia are uploaded to/downloaded from the Internet. The process proceeds to block 506 upon receipt of a downloaded image.

In block 506, the downloaded image is scanned. The process proceeds to block decision block 508.

In decision block 508, it is determined whether an embedded code is detected in the downloaded image. If an embedded code is not detected in the downloaded image, the process proceeds to block 510.

In block 510, the downloaded image is displayed as is. In other words, the image that is displayed is not a protected image and may be displayed without any DRM protection. The process proceeds back to block 504 to wait for the next downloaded image.

Returning to decision block 508, if it is determined that embedded code is detected in the downloaded image, the image is a proxy image. Proxy images indicate that an actual image is being protected from unauthorized access. The process proceeds to block 512.

In block 512, the proxy image is decoded to obtain the ID code that references the actual image and the user's access privileges are retrieved. The process then proceeds to decision block 514.

In decision block 514, it is determined whether the user has enough privileges to view the actual image. If it is determined that the user does not have enough privileges to view the actual image, the process proceeds to block 516.

In block 516, a placeholder image may be displayed and the user is notified that the user does not have enough privileges to see the actual image. The process then proceeds back to block 504 to wait for the next downloaded image.

Returning to decision block 514, if it is determined that the user does have enough privileges to view the actual image, the process proceeds to block 518. In block 518, actual encrypted image 308 is fetched from secure repository 306 of cloud storage network 110. Actual encrypted image 308 is decrypted using a key from the authorization server 310 to obtain the actual image, and the actual image is placed atop of proxy image 302 for display to the user. The process then proceeds back to block 504, where browser plug-in 138 waits for the next downloaded image.

In one embodiment of the present invention, the user may not be aware of the proxy image 302, and never views the proxy image 302. In fact, the user may only see an actual image or a placeholder image for the retrieved web page. In other embodiments, the user may see the proxy image 302.

As previously indicated, once the actual image is inside the browser, DRM protection mechanisms may be used to ensure the proper usage and manipulation of the protected image (actual image). For example, DRM protection may prevent unauthorized copying of the actual image.

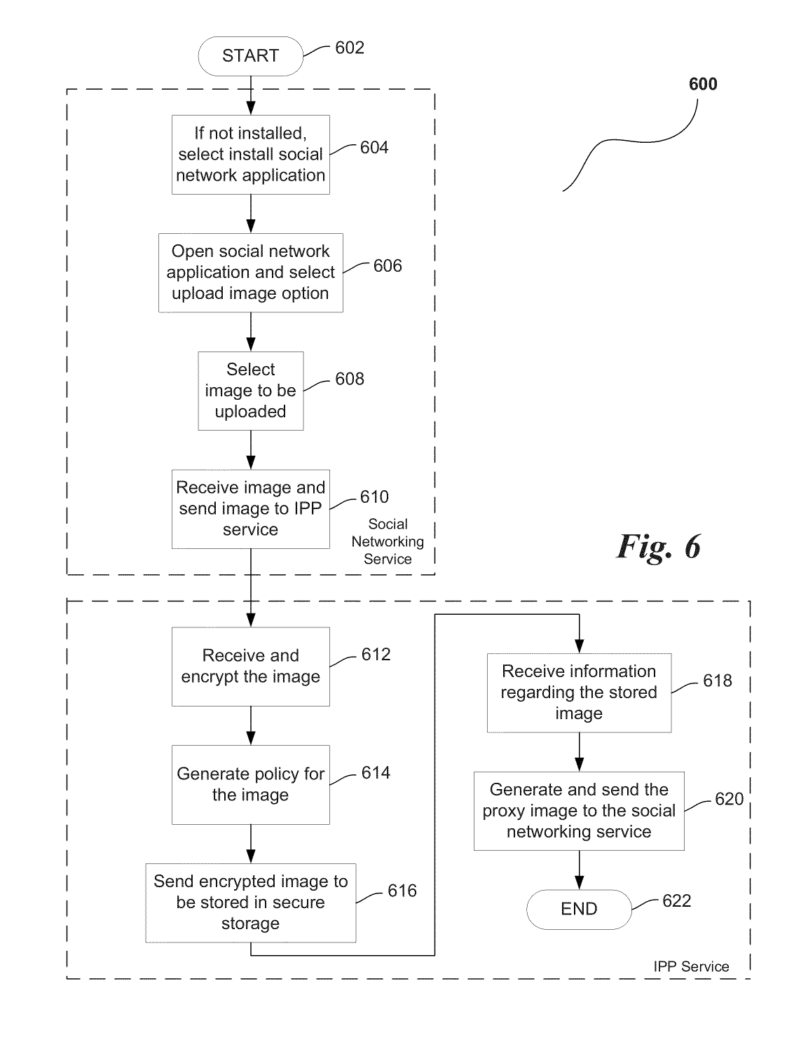

FIG. 6 is a flow diagram 600 describing a method for uploading multimedia according to an embodiment of the present invention. The invention is not limited to the embodiment described herein with respect to flow diagram 600. Rather, it will be apparent to persons skilled in the relevant art(s) after reading the teachings provided herein that other functional flow diagrams are within the scope of the invention. The process begins with block 602, where the process immediately proceeds to block 604.

In block 604, a user may select a social network application 146 to be installed from the social networking service 106. If the user has already installed the social network application 146, this process may be skipped. The process then proceeds to block 606.

In block 606, after the social network application 146 has been installed, the user may open the application by clicking on a link from the social networking service 106. Upon opening the social network application 146, the user may select an option for uploading images. The process then proceeds to block 608.

In block 608, upon selecting the option for uploading images, the user may be prompted to select an image from the user's hard drive. The process then proceeds to block 610.

In block 610, the image is received by the social network application and sent to the Internet privacy protection service 102. The process then proceeds to block 612.

In block 612, Internet privacy protection service 102 receives the image and requests that the DRM module 126 encrypt the image. The process then proceeds to block 614.

In block 614, the DRM module may interact with the federated privacy module 120 to generate the appropriate policy for the image (i.e., media item). The policy may include, but is not limited to, who may view the image, and whether the image may be copied, forwarded, printed, or modified. In one embodiment, the federated privacy module 120 may query the subscriber to determine who may view the image and whether the image may be copied, forwarded, printed, or modified. The subscriber may also set an expiration date as well as the number of times a media item may be viewed in general or by a particular person. Once the policy for the image has been determined, the process proceeds to block 616.

In block 616, the IPP service 102 sends the encrypted image to the cloud storage network 110 to be stored in the secure repository 306 of cloud storage network 110. The process then proceeds to block 618.

In block 618, information regarding the stored image, including the location of the stored image in secure repository 306, is received by the Internet privacy protection service 102. The process then proceeds to block 620.

In block 620, Internet privacy protection service 102, upon receiving information regarding the stored image in secure repository 306, generates the proxy image 302 (as described above with reference to FIG. 4) and sends the proxy image to the social networking service 106. The proxy image is generated by the proxy generation module 128. The process then proceeds to block 622, where the process ends.

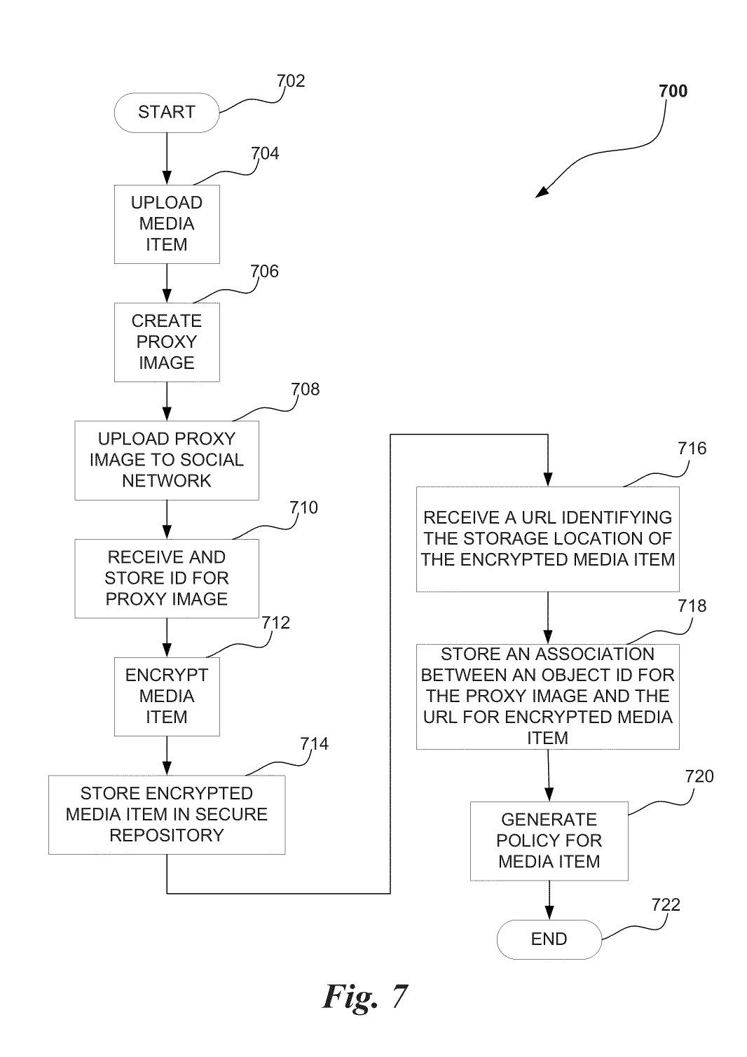

In an alternative embodiment of the present invention, proxy images may be comprised of blurred versions of the actual (i.e., original) media image with the identification for the actual image being part of the image metadata on the social network page. FIG. 7 is a flow diagram 700 illustrating an alternative exemplary method for uploading multimedia according to an embodiment of the present invention. The invention is not limited to the embodiment described herein with respect to flow diagram 700. Rather, it will be apparent to persons skilled in the relevant art(s) after reading the teachings provided herein that other functional flow diagrams are within the scope of the invention. The process begins with block 702, where the process immediately proceeds to block 704.

In block 704, a media item is uploaded by the subscriber to the IPP service 102 from client 104. The process proceeds to block 706.

In block 706, a proxy image is created. The proxy image may be a blurred image of the original uploaded media item. The process proceeds to block 708.

In block 708, the proxy image may be uploaded to the social network service 106. The process then proceeds to block 710.

In block 710, the metadata from the proxy image object on the social network service 106 may be used as the unique identifier (ID) for the proxy image. This unique ID is sent to, and stored on, the IPP service 102. The process then proceeds to block 712.

In block 712, the media item is encrypted by the DRM module 126 of the IPP service 102. The process then proceeds to block 714.

In block 714, the encrypted media item is sent to cloud storage network 110 for storage in a secure repository, such as secure repository 306. The process proceeds to block 716.

In block 716, information regarding the stored image (i.e., the encrypted media item), including the location of the stored image in the secure repository 306 of the cloud storage network 110, is received by the Internet privacy protection (IPP) service 102. The process then proceeds to block 718.

In block 718, the IPP service 102 stores an association between the unique identifier for the proxy image and the information received from the cloud storage network 110 regarding the stored image in the secure repository 306. The association allows the correct stored image in the secure repository 306 to be retrieved based on the unique identifier. The process then proceeds to block 720.

In block 720, the DRM module may interact with the federated privacy module 120 to generate the appropriate policy for the media item. The policy may include, but is not limited to, who may view the image, and whether the image may be copied, forwarded, printed, or modified. In one embodiment, the federated privacy module 120 may query the subscriber to determine who may view the image and whether the image may be copied, forwarded, printed, or modified. The subscriber may also set an expiration date as well as the number of times a media item may be viewed in general or by a particular person. Once the policy for the image has been determined, the process proceeds to block 722, where the process ends.

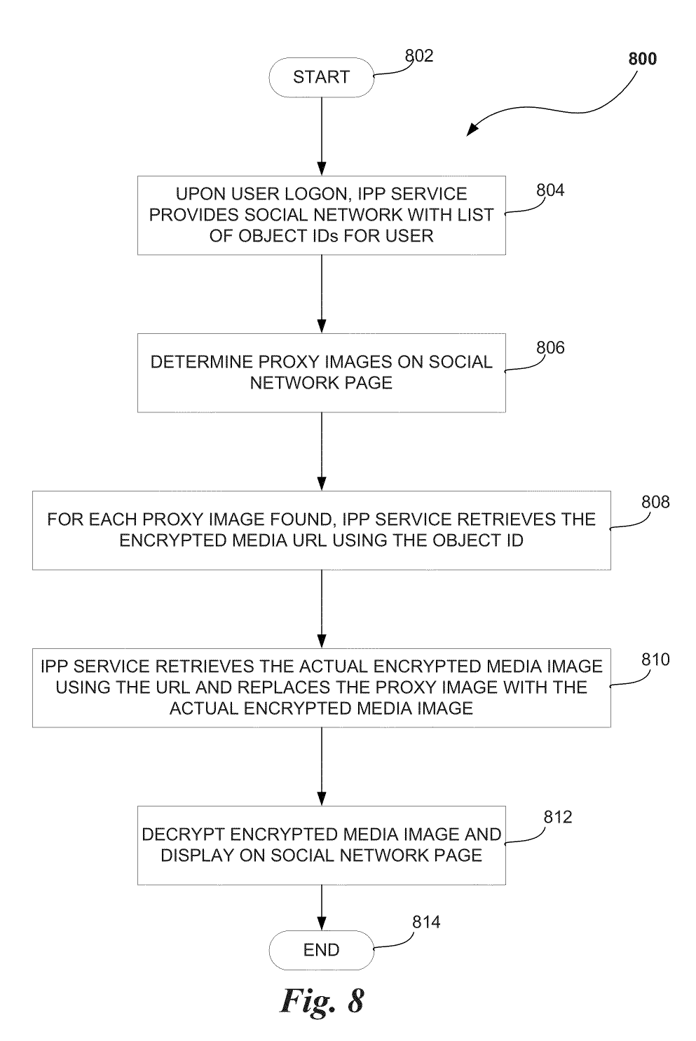

Media images on the social network service 106 may be identified as proxy images using the metadata from the image object. Once the proxy image is identified, the actual image may be downloaded for viewing. FIG. 8 is a flow diagram 800 illustrating an alternative exemplary method for viewing multimedia according to an embodiment of the present invention. The invention is not limited to the embodiment described herein with respect to flow diagram 800. Rather, it will be apparent to persons skilled in the relevant art(s) after reading the teachings provided herein that other functional flow diagrams are within the scope of the invention. The process begins with block 802, where the process immediately proceeds to block 804.

In block 804, when a user logs onto a social network service, such as, for example, social network service 106, the IPP service provides the social network service with a list of media items (i.e, a list of object IDs) that the user may view. The process proceeds to block 806.

In block 806, social network page is scanned to determine which images on the page are proxy images. If an image on the page contains an object ID from the list of object IDs for the user in its metadata, the image is a proxy image. The process proceeds to block 808.

In block 808, for each image identified as a proxy image, the IPP service 102 retrieves the encrypted media URL using the object ID. The process then proceeds to block 810.

In block 810, the IPP service 102 retrieves the actual encrypted media image using the URL and replaces the proxy image with the actual encrypted media image on the social network page. The process proceeds to block 812.

In block 812, the encrypted media images are decrypted and then displayed on the social network page. The process then proceeds to block 814, where the process ends.

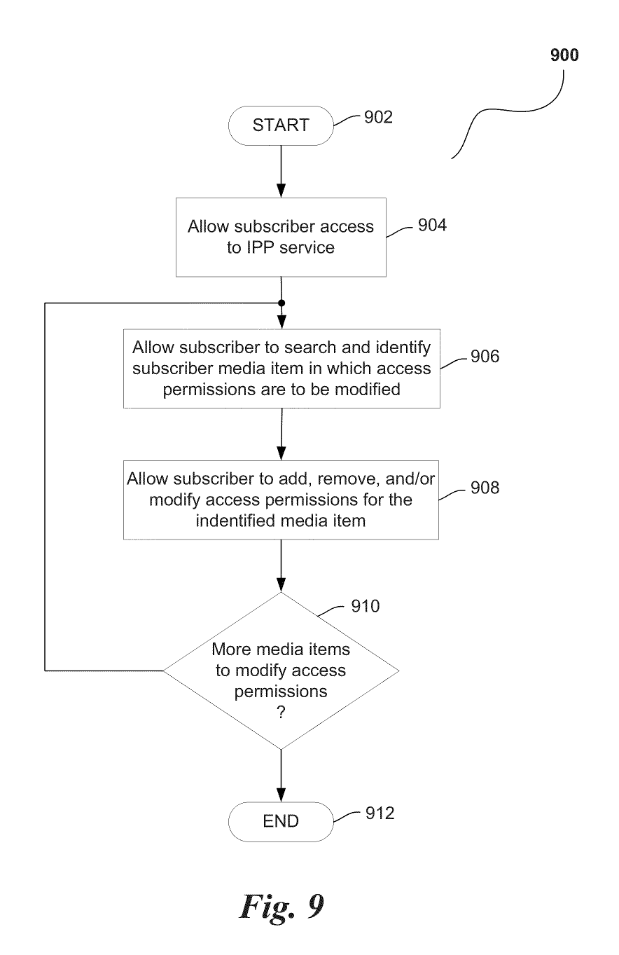

Embodiments of the present invention also allow a subscriber to modify access permissions to a media item at any time. FIG. 9 is a flow diagram 900 illustrating an exemplary method for adding, removing, and/or modifying access permissions for a media item at any time according to an embodiment of the present invention. The invention is not limited to the embodiment described herein with respect to flow diagram 900. Rather, it will be apparent to persons skilled in the relevant art(s) after reading the teachings provided herein that other functional flow diagrams are within the scope of the invention. The process begins with block 902, where the process immediately proceeds to block 904.

In block 904, a subscriber obtains access to the IPP service 102. In one embodiment, the subscriber may obtain access to the IPP service 102 from the social networking service 106 via social network application 146. In one embodiment, the subscriber may obtain access to the IPP service 102 directly from the web portal 122. The process proceeds to block 906.

In block 906, the subscriber may search through the media and select the media item that the subscriber would like to modify the access permissions. Once the subscriber has identified the media item, the process proceeds to block 908.

In block 908, the federated privacy module may be used to add, remove, and/or modify the access permissions for the media item accordingly. In one embodiment, the changes are provided to the federated privacy module 120 by the subscriber via the web portal 122. In another embodiment, access permissions for a media item may be modified by providing the changes to the federated privacy module 120 through the social network application 146 via the social network user interface 144. The process then proceeds to decision block 910.

In decision block 910, the subscriber is queried as to whether there are other media items with access permissions to be changed. If there are other media items in which access permissions are to be changed, the process proceeds back to block 906. If there are no more media items with access permissions to be changed, the process proceeds to block 912, where the process ends.

Embodiments of the present invention may be implemented using hardware, firmware, software, and/or a combination thereof and may be implemented in one or more computer systems or other processing systems. In fact, in one embodiment, the invention is directed toward one or more computer systems capable of carrying out the functionality described here. For example, the one or more computer systems may include server systems for implementing the IPP service 102 and the social networking service 106 and client systems for implementing client platforms 104.

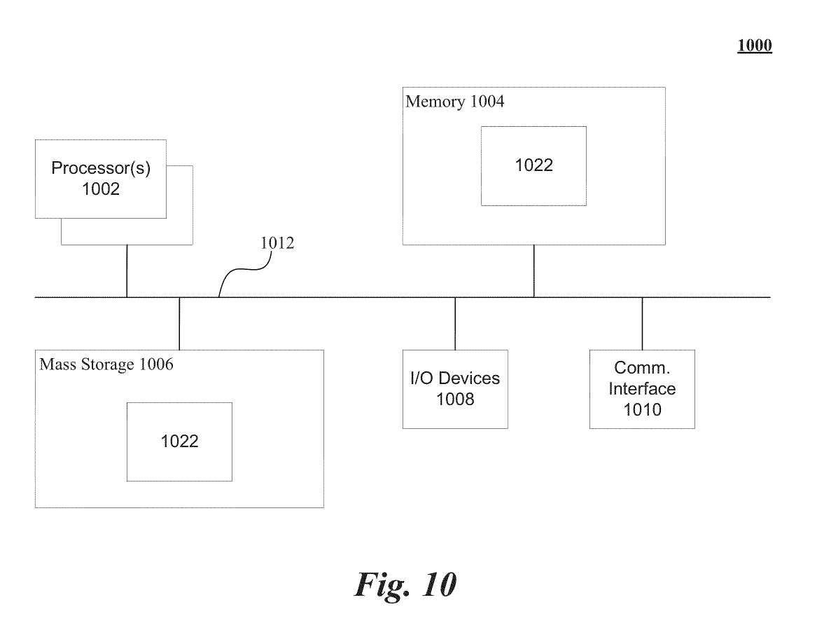

FIG. 10 illustrates an example computer system suitable for use to practice various embodiments of the present invention. As shown, computing system 1000 may include a number of processors or processor cores 1002, a system memory 1004, and a communication interface 1010. For the purpose of this application, including the claims, in the terms “processor” and “processor cores” may be considered synonymous, unless the context clearly requires otherwise.

Additionally, computing system 1000 may include tangible non-transitory mass storage devices 1006 (such as diskette, hard drive, compact disc read only memory (CDROM) and so forth), input/output devices 1008 (such as keyboard, cursor control and so forth). The elements may be coupled to each other via system bus 1012, which represents one or more buses. In the case of multiple buses, they are bridged by one or more bus bridges (not shown).

Each of these elements may perform its conventional functions known in the art. In particular, system memory 1004 and mass storage 1006 may be employed to store a working copy and a permanent copy of the programming instructions implementing one or more operating systems, drivers, applications, and so forth, herein collectively denoted as 1022.

The permanent copy of the programming instructions may be placed into permanent storage 1006 in the factory, or in the field, through, for example, a distribution medium (not shown), such as a compact disc (CD), or through communication interface 1010 (from a distribution server (not shown)). That is, one or more distribution media having an implementation of the agent program may be employed to distribute the agent and program various computing devices.

The remaining constitution of these elements 1002-1012 are known, and accordingly will not be further described.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

1-51. (canceled)

52. A face recognition method, comprising:
monitoring, by a face recognition module located on a server of an Internet privacy protection (IPP) service, images uploaded to a web site;
determining, by the face recognition module, whether an image includes facial features of a subscriber of the IPP service;
if the image includes facial features of the subscriber, then
notifying the subscriber, wherein notifying the subscriber includes sending, by the IPP service, a copy of the image to the subscriber to allow the subscriber to determine whether the subscriber is included in the image; and
receiving, by the IPP service, a response from the subscriber, wherein if the response is a report of misuse, notifying, by the IPP service, the web site of the report of misuse.

53. The method of claim 52, wherein the web site comprises a social network web site.

54. The method of claim 53, wherein the images uploaded comprise images uploaded by one or more members of the subscriber's social circle.

55. The method of claim 52, wherein notifying the subscriber includes a request to the subscriber to verify the appearance of the subscriber in the image.

56. The method of claim 52, wherein if the response indicates that the image is not the subscriber, notifying the web site that the image is not the subscriber.

57. The method of claim 52, wherein if the response indicates that the image is the subscriber and that the subscriber would like to be tagged, notifying the web site that the image is the subscriber and that the subscriber wants to be tagged.

58. The method of claim 52, wherein if the response indicates that the image is the subscriber, and that the subscriber does not want to be tagged, notifying the web site that the image is the subscriber and that the subscriber does not want to be tagged.

59. The method of claim 52, wherein prior to monitoring images uploaded to a web site, the method comprises training the face recognition module using images of the subscriber obtained from a web cam of a client device of the subscriber.

60. The method of claim 52, wherein prior to monitoring images uploaded to a web site, the method comprises training a face recognition module using images of the subscriber uploaded from a social network site.

61. The method of claim 52, wherein during subscription to the IPP service, at least one signature of the subscriber's face is created to help detect the subscriber's face on multimedia published by a contact of the subscriber's social circle across multiple social networks.

62. An Internet privacy protection (IPP) system, comprising:
an IPP service in communication with a plurality of client platforms and one or more social networking services over a wide area network, the IPP service having one or more servers to provide a mechanism to allow a subscriber of the IPP service to control access to the subscriber's media and to provide a mechanism to detect any privacy breaches of the subscriber's media.

63. The IPP system of claim 62, wherein the IPP service further comprises:
a federated privacy module to provide a centralized point to enable the subscribers to configure the subscribers' privacy policy for one or more social networking sites;
a web portal to provide a direct interface between the IPP service and the plurality of client platforms to enable the subscribers to modify subscription and privacy information;
a subscription module to manage processes for obtaining and maintaining subscriptions with the IPP service from a plurality of subscribers;
a Digital Rights Management (DRM) module to manage server side DRM features;
a proxy image generator to generate proxy images for multimedia images uploaded to the social networking service by the subscribers; and
a face recognition module to monitor each subscriber's appearance on the multimedia images uploaded by each subscriber's contacts to any monitored social network.

64. The IPP system of claim 63, wherein the privacy policy comprises privacy settings associated with each social network of the subscribers, privacy settings associated with each media item of a subscriber, unified subscriber contacts across social networks, unified group contacts across social networks, etc.

65. The IPP system of claim 63, wherein the web portal to further allow the subscribers to view all of a subscribers' media items and to interact with the federated privacy module to update the privacy policy for any of the subscribers' media items.

66. The IPP system of claim 63, wherein a subscriber subscribes to the IPP service from the social networking service by clicking on a link identifying the IPP service.

67. The IPP system of claim 63, wherein a subscriber subscribes to the IPP service from one of the plurality of client platforms via the web portal.

68. The IPP system of claim 63, wherein the server side DRM features comprise encrypting multimedia images, authenticating subscriber contacts, providing keys to subscriber contacts to decrypt the encrypted multimedia images, encrypting and holding multimedia content, and packaging, encrypting and provisioning licenses to subscriber contacts.

69. The IPP system of claim 63, wherein the proxy images are used as placeholders for actual multimedia images until permission to view the multimedia images by subscriber contacts is verified.

70. The IPP system of claim 69, wherein the proxy images are encoded with a location of the actual media image using a bar code.

71. The IPP system of claim 69, wherein the proxy images are blurred versions of the actual images and the location of the actual images are part of the image metadata.

72. The IPP system of claim 69, wherein the face recognition module to be trained on each subscriber's face from a set of subscriber pictures.

73. The IPP system of claim 72, wherein the set of subscriber pictures are taken using a web cam of a client platform and uploaded to the IPP service via the web portal.

74. The IPP system of claim 72, wherein the set of subscriber pictures are uploaded to the IPP service via a social network application on a social networking site.

75. The IPP system of claim 62, wherein each of the plurality of client platforms includes a DRM agent, a DRM module and a browser plug-in, wherein the DRM agent, in conjunction with the DRM module, to enforce all DRM policies from the IPP service including decisions on whether an action is to be performed on a media item, and wherein the browser plug-in to detect the proxy image, to request the encrypted media item and license from the IPP service for the DRM agent, and to display the media item securely on the user's display device.

76. An article comprising: a storage medium having a plurality of machine accessible instructions, wherein when the instructions are executed by a processor, the instructions provide for monitoring, by a face recognition module located on a server of an Internet privacy protection (IPP) service, images uploaded to a web site;
determining, by the face recognition module, whether an image includes facial features of a subscriber of the IPP service;
if the image includes facial features of the subscriber, then
notifying the subscriber, wherein notifying the subscriber includes sending, by the IPP service, a copy of the image to the subscriber to allow the subscriber to determine whether the subscriber is included in the image; and
receiving, by the IPP service, a response from the subscriber, wherein if the response is a report of misuse, notifying, by the IPP service, the web site of the report of misuse.

77. The article of claim 76, wherein the web site comprises a social network web site.

78. The article of claim 77, wherein the images uploaded comprise images uploaded by one or more members of the subscriber's social circle.

79. The article of claim 76, wherein instructions for notifying the subscriber include a request to the subscriber to verify the appearance of the subscriber in the image.

80. The article of claim 76, wherein if the response indicates that the image is not the subscriber, the instructions further provide for notifying the web site that the image is not the subscriber.

81. The article of claim 76, wherein during subscription to the IPP service, at least one signature of the subscriber's face is created to help detect the subscriber's face on multimedia published by a contact of the subscriber's social circle across multiple social networks.
